(19) United States
(12) Patent Application Publication
(10) Pub. No.: US 2005/0144044 A1
(43) Pub. Date: Jun. 30, 2005

(54) System and apparatus for efficiently utilizing network capacity in a healthcare setting

(75) Inventors: Christopher Brian Godschall, Ellicott City, MD (US); Michael Treat VanSickler, Columbia, MD (US); Victor Maclean Ebeneza Kaitell, Owings Mills, MD (US)

Correspondence Address: Stacey J. Longanecker;Roylance , Abrams, Berdo & Goodman, L.L.P., Suite 600, 1300 19th Street, N.W., Washington, DC, 20036, US

(73) Assignee: Samsung Electronics Co., Ltd.

(21) Appl. No.: 10/952,448

(22) Filed: Sep. 29, 2004

Related U.S. Application Data
(60) Provisional application No. 60/506,150, filed on Sep. 29, 2003.

(51) Int. Cl. G06F 17/60

(52) U.S. Cl. 705/3

(57) ABSTRACT

A handheld or portable computing device is provided and capable of providing efficient maintenance of information maintained or stored within a healthcare information system such as an LIS (laboratory information system). Periodically updating information with the server allows the user to perform many specimen collection related tasks efficiently. The handheld device and related system provide improved monitoring of diagnostic sample collection errors and further provides efficient network management of accessing and updating the information on a server through communications with the network such as ping synchronization communications and use of a valid data timer element.

This application claims the benefit of U.S. provisional application Ser. No. 60/506,150, filed Sep. 29, 2003.

### FIELD OF THE INVENTION

The present invention generally relates to remote networked medical error management devices, systems, and methods for using and operating the same. In particular, the present invention relates to a remote medical error management device having functionality to monitor, facilitate, and audit medical services. This functionality can be achieved with a reader for reading bar-coded products such as specimen collection containers. Additionally, the present invention can also apply to error management devices for reading containers or vessels containing therapeutics such as infusible medication.

More specifically, the present invention relates to handheld computers or portable-computing systems for providing efficient updating of patient specimen collection orders performed manually in hospital environments.

### BACKGROUND OF THE INVENTION

Portable computing devices utilizing software for medical error management are becoming increasingly common as medical healthcare technology improves. A portable computing device can collect clinical and non-clinical information about the sample collection process at a hospital, laboratory, or blood collection facility or clinic. To better manage patient-related testing results and the specimens from which those results were derived from, it is important to track the collected specimens and match them to the patient's identification information, which is typically stored in patient and specimen order databases such as hospital or laboratory information systems.

The proposed invention allows a hospital or laboratory technician such as a phlebotomist, doctor, or nurse to efficiently update specimen collection order information on a handheld device.

### SUMMARY OF THE INVENTION

Laboratory Information Systems (LISs) and Hospital Information Systems (HISs) both fall under the category of Health Care Information or Enterprise Systems. Generally, health care enterprises provide various aspects of patient care such as patient identification and tracking, as well as medication and sample collection order and data management.

In providing patient care, health care workers typically utilize one or more software applications accessible through a health care information system. Access to health care information systems have, in the past, required fixed terminals such as nurse workstations to be used at a location potentially distant from the point of use (i.e., at the patient's location). To provide more convenient and efficient access to an LIS, more portable modules such as handheld computers or portable data terminals (PDTs) have recently been introduced into health care and hospital settings and are hereinafter generally referred to as “handhelds”. The handhelds can be connected to a server directly through a LAN, modem, or wireless connection. Optionally, the handhelds can be connected to a server through a PC using a serial connection.

In order to use the handheld, the information on the handheld must be synchronized with the LIS by connecting the handheld to a data import/export device connected with the LIS, or via a cable connected with the LIS, to allow the exchange of data between the LIS and the handheld.

One possible method to achieve this goal is to continuously synchronize data between the handheld device and the server through a wireless network connection. However, with this method, the handheld can reach areas in the hospital or clinical setting known as a dead-zone, where wireless communication is interrupted or unavailable, causing possible operation failure. Current complications with wireless systems due to their technological infancy in the health care setting, and potential interference with other wireless devices, demand a solution that will not be so easily interrupted. It is foreseeable that technological advances in server to handheld technology will evolve to reduce or eliminate the associated problems discussed above. Presently, however, there is a definite need to provide server to handheld communication and synchronization features for health care facilities such as hospitals in an asynchronous environment.

One approach to meet this challenge is to operate in an asynchronous environment where the handheld is updated intermittently. In this case, the handheld is not permanently connected to the LIS via the data import/export device or cable, thus providing a time period during use where the information contained on the handheld does not exactly mirror the content contained within the server. Accordingly, this uncertainty of information requires a need for intermittent synchronization of information between the handheld and the server due to the user's concern that the information contained on the handheld might not match that on the LIS. An example of a known system is described in published European Patent Application No. EP1003121, published on May 24, 2000, the entire content of which is incorporated herein by reference.

Current systems and practices do not facilitate efficient and accurate communication of patient information between the handheld and the server, thus clarifying the need for the present invention. The present invention utilizes specific “ping” type communication technologies to allow improved automated specimen and medication management data synchronization through the handheld to LIS and server network communications.

### BRIEF DESCRIPTION OF THE DRAWINGS

These and other aspects, advantages and novel features of the present invention will be readily comprehended from the following detailed description when read in conjunction with the accompanying drawings:

FIGS. 1, 2, 3 and 4 each illustrate a client handheld(s) and server configured in accordance with the present invention in use with different configurations of a health care information or enterprise system;

FIG. 5 is a block diagram illustrating a client handheld configured in accordance with an embodiment of the present invention;

FIG. 6 a block diagram illustrating a server configured in accordance with an embodiment of the present invention;

FIG. 7 depicts a client handheld configured in accordance with an embodiment of the present invention in use with a specimen container and corresponding bar code label;

FIG. 8 is a flow chart depicting a sequence of operations for controlling a client handheld(s) and server in accordance with an embodiment of the present invention; and

FIG. 9 depicts an exemplary client handheld configured in accordance with an embodiment of the present invention.

### DETAILED DESCRIPTION OF THE PREFERRED EMBODIMENTS

Nurses, doctors, and phlebotomists can use handheld patient information systems for managing specimen collection and medication administration tasks. Since multiple nurses or phlebotomists can work on the same ward, wing, or floor of a hospital or other healthcare setting, there is a chance that specimen collection orders, for example, will be collected and not updated with the information contained on other handhelds. More specifically, a handheld may not have up-to-date information for blood or urine sample collection procedures where the sample collection orders have been modified in the LIS after the data on the handheld has been updated. Current handhelds operating in asynchronous environments can drive the user to constantly synchronize the handheld with the LIS to update the entire information on the handheld. Furthermore, the time required to update each handheld might run on the order of minutes, causing significant and unnecessary delays for the health care worker to perform his or her task(s). To avoid these delays, there is a need for improved and efficient synchronization technologies applicable to asynchronous handheld/server systems. The present invention described herein will therefore demonstrate how some of the above-identified problems are avoided or alleviated.

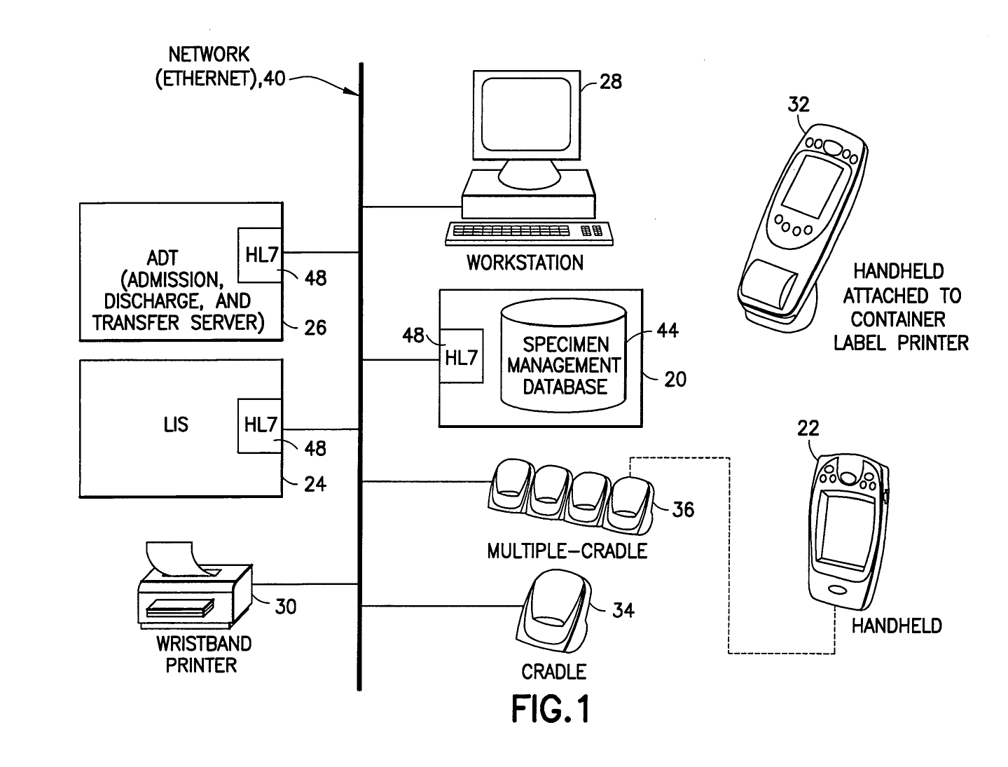

With reference to FIGS. 1 through 4, the present invention described herein preferably comprises a server 20 (e.g., a specimen management server (SMS), a plurality of client handhelds 22 with data accessibility to the server 20, a LIS (laboratory information system) 24, and an ADT system (admission, discharge, and transfer system) 26. The components are connected to a network to allow for specific communication events to occur. Other embodiments might include aspects of the server 20 embedded into the LIS 24 instead.

To understand the present invention, certain terms shall be defined as follows:

Definitions

Client

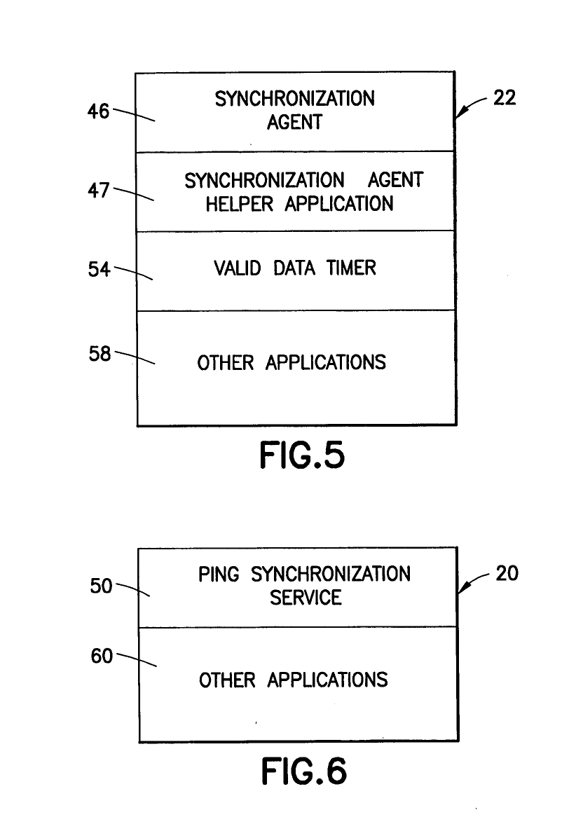

The client 22 is the handheld device that can download files and data for manipulation, run applications, or request application-based services from a file server. In addition to the operating applications 58, the client maintains a synchronization agent 46 (FIG. 5) allowing for the control of data transfer from the specimen management server (SMS) 20. In accordance with one embodiment of the present invention, a synchronization agent helper application 47 determines the opportunity and necessity for synchronization between the client 22 and specimen management server 20 in order to optimize network and server resources. This application initiates passively upon a user-configured interval time, or actively upon special events such as physical reattachment to the network or enablement of an actuator.

Cradle

A cradle 34 is a docking station used to provide an interface with a host terminal. The cradle 34 can be adapted to receive and secure the handheld 22. A detector element can be included to detect when the handheld 22 is placed in the cradle. Data can be received from a server 20 and selectively downloaded when the handheld is placed in the cradle. In one embodiment of the present invention, the server 20 is a specimen management server (SMS). An actuator on the handheld can be employed for initiating the transfer of data to a process in the host terminal if the detector indicates that the handheld 22 has been placed in the cradle 34.

Collection Container Label Printer

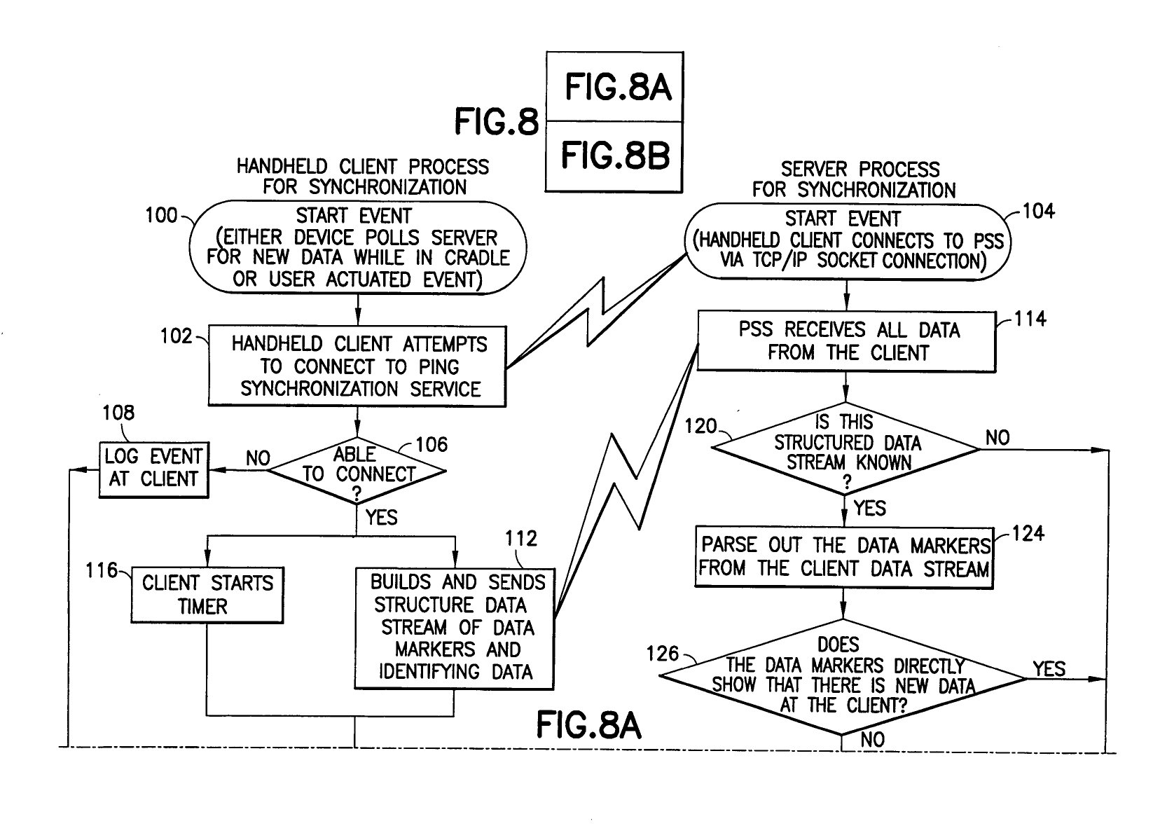

The collection container label printer 32 is a printer intended for printing labels at the point of use, such as the point of sample collection. More specifically, in certain locations within the healthcare setting, collection container label printers are needed for printing labels with indicia of the collected sample for downstream tracking and processing of the sample, such as which patient the sample was taken from, and other information useful for the healthcare worker or laboratory technician. Ideally blood collection containers 56 (FIG. 7) would be available to the health care worker including a barcode 52 or RFID (radio frequency identification) tag communicating tube specific information to be registered with the portable handheld device 22 of the present invention. In one embodiment, the barcode label 52 is printed upon scanning of a collection container's barcode after the user and patient have both been scanned into the system. The barcode printer 32 can be located or housed on a phlebotomy cart or tray or mounted in a patient's room. The printer 32 creates a customized label 52 containing the bar code accession number that the LIS 24 has assigned to the specimen.

Database

The term database (e.g., the specimen management database (SMD) 44) includes one or more large structured sets of persistent data, usually associated with software to update, insert, and query the data.

Handheld

The term handheld (e.g., client handheld 22) describes portable computers useful for executing specimen or medication management at the point of use. An example of such a portable handheld element is the Symbol Technologies PPT 1700. Series Pocket PC. This specific handheld has IR and barcode scanning capabilities. The handheld comprises a graphical user interface (GUI) for displaying information useful for collecting specimen samples from a patient.

Preferably, the handheld includes a microprocessor, reading element such as a bar code scanner, and printing element. The reading element is capable of reading identification information from a patient identification code and printing a corresponding information label. The microprocessor is capable of processing data relating to the identification information. The handheld ideally comprises a miniature identification capture reader. The identification capture reader could be a barcode scanner, imager, infrared identification reader, RF identification reader or similar technology. A barcode scanner could be integrated into the medical handheld device or attached to the medical handheld device via an accessory device.

The handheld preferably includes a battery, a display screen for the GUI, depressible keys, communication circuitry, a memory element, a housing for securing all the handheld subcomponents, and a microprocessor. The portable handheld device could be a portable digital assistant (PDA), tablet PC, or notebook computer that includes a module and/or software for communicating with a server.

HIS

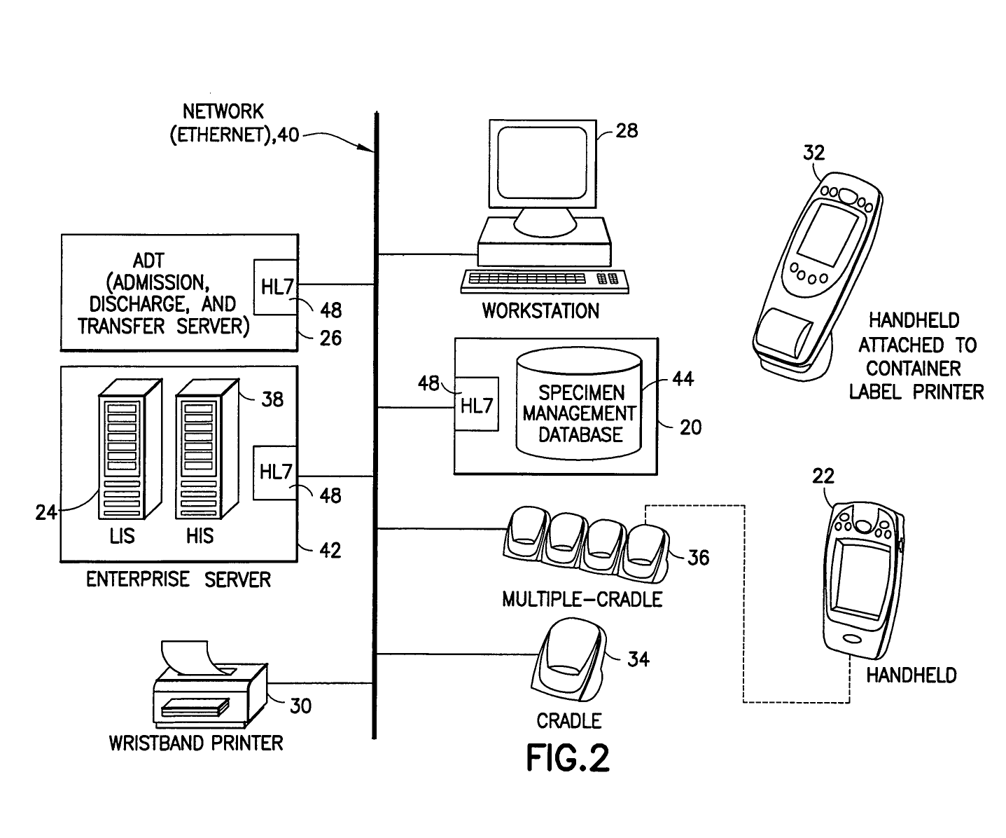

The Hospital Information System (HIS) 38 (FIG. 2) is a system developed with the objective of managing and streamlining the treatment flow of a patient in the hospital, along with all data associated with the patient necessary for efficient and organized healthcare service. Treatment flow includes, but is not limited to, specimen management and medication management. The HIS allows doctors and other staff to perform to their peak ability in an optimized and efficient manner. Most HIS's are modular, thus ensuring sustained benefits through changes in technology such as integration with new and improved LIS (laboratory information system) and ADT (admissions, discharge, and transfer) systems 24 and 26.

HISs 38 use a network of computers to gather, process, and retrieve patient care and administrative information for most hospital activities to satisfy the functional requirement of the users. HISs also help to provide decision support systems for hospital authorities developing and managing comprehensive health care policies.

HISs 38 incorporate integrated computerized clinical information systems for improved hospital administration and patient health care. They also provide for accurate, electronically stored medical records for one or many patients. Typically, HISs are centralized information systems designed for quick delivery of operational and administrative information and include software capable of optimizing core data and other application modules customizable to the hospital or healthcare facility.

LIS

The term LIS 24 preferably defines a computer network comprised of industry standard network hardware and software (network and communication protocols) that serves to allow communication between the patient health record repository, the end-user client applications running on various device types, and the various types of servers. This network can take the form of a cable-based or fiber optic network, a local area network (LAN), a wide area network (WAN), a virtual private network (VPN), the Internet, or any other type of network that allows communication between computing devices.

The LIS typically is limited to laboratory information systems that organize and track information pertaining to laboratory tasks such as how orders are generated and communicated to the lab, how patients or samples are delivered, how the samples are accessioned and prepared, how testing is actually accomplished, and how results are communicated to healthcare providers. LISs can also organize, track, and determine how the health enterprise is reimbursed for the work done in the lab, and how the reimbursement information is exchanged.

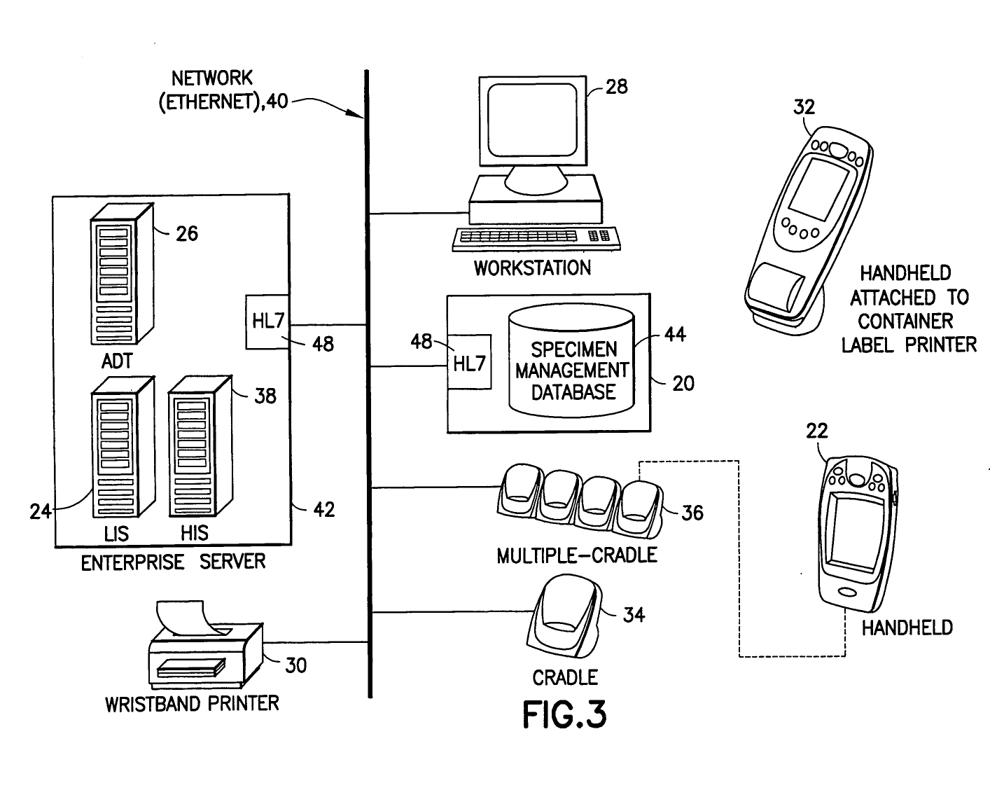

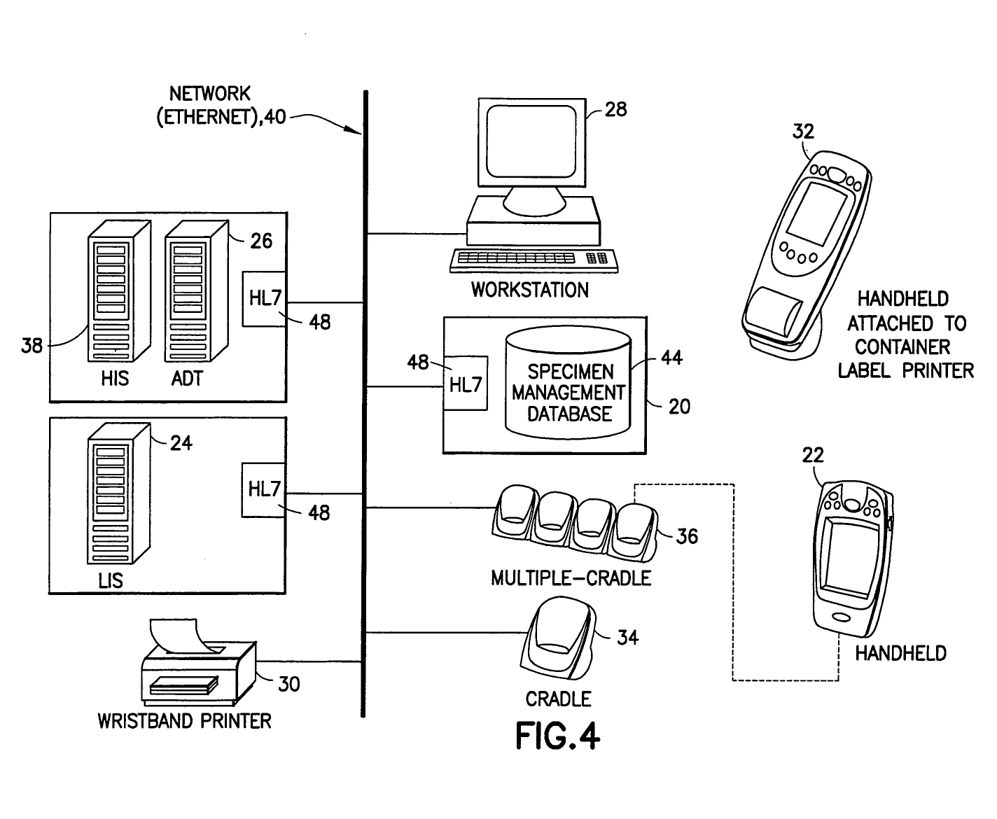

As shown in FIG. 2, an enterpriser server 42 can comprise the LIS 24 and the HIS 38, or the ADT 26, LIS 24 and the HIS 38, as shown in FIG. 3. Alternatively, the HIS 38 and the ADT 26 operations can be combined in a single server (FIG. 4), among other configurations.

LIS/HIS Data Interface

The LIS/HIS data interface 48 is an element for allowing for facilitated communication for multiple modules sending and receiving data packets and signals across a network. Examples include Health Level Seven (i.e. HL7 3.0), ASTM 1238, ASTM 1394, Dbase, Comma Delimited ASCII, and Fixed Length ASCII.

Patient ID Printer

The patient ID printer 30 is a printer typically designated for printing patient ID tags such as wristbands critical for accurate and efficient patient identification and safety. Patient ID tag printers are usually connected to a network and communicate with the ADT and HIS systems 26 and 38.

Ping Synchronization Service

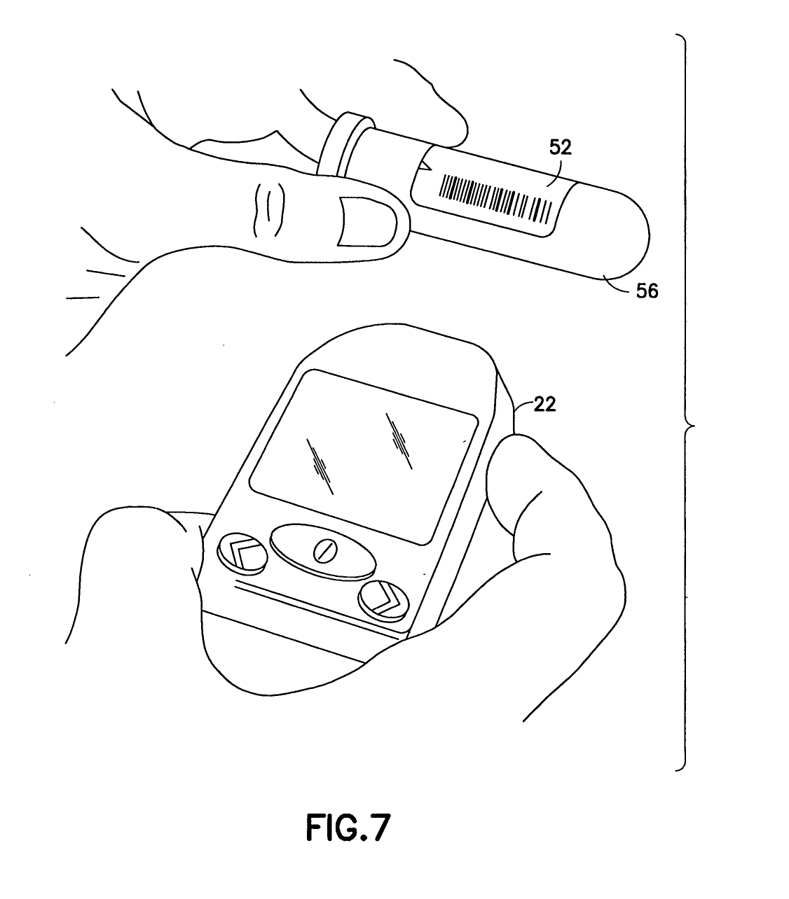

The Ping Synchronization Service (PSS) 50 (FIG. 6) is an application residing within the specimen management server 20 that handles communication with the handheld client 22. The PSS 50 is responsible for receiving communication requests and data, interpreting and comparing data, and finally submitting a response back to the handheld client.

Specimen Management Server

The specimen management server (SMS) is a server 20 comprising a database and other programs and modules 60 (FIG. 6) for running and integrating LIS 24, HIS 38, and client handheld systems 22 (e.g., a web server, a SQL server, a LIS to SQL parsing application, and so on). Typically, the specimen management server 20 creates and updates its database with information specific to patients, specimen samples collected from those patients, and medications administered to those patients. The specimen management server 20 in some embodiments is capable of executing a ping synchronization service 50 to maintain intermittent communication with the client 22. In some embodiments of the present invention, functionality of the specimen management server 20 can be integral to the LIS 24, HIS 38, or both. In other embodiments of the present invention, the SMS 20 can be separate from the LIS 24 and HIS 38, but run on the same network as the LIS 24 in order to receive updated information related to sample orders and accession numbers generated through the LIS 24.

Query

The term query includes a client's request for information, generally as a formal request to a database. In one embodiment of the present invention, the database is accessed using Microsoft's SQL database query language.

SQL

SQL is an acronym for structured query language and includes a language that provides a user interface to relational database management systems.

Valid Data Timer

The valid data timer is a handheld timer programmable by the user or system administrator to let the user know how long a handheld 22 can be “out of the cradle” before it must be re-cradled. The time is reset after every successful synchronization between the server 20 and the handheld 22. Therefore, when the user takes the handheld out of the cradle, the timer should be reset to the maximum value. In some embodiments, the handheld can display the remaining minutes on the handheld screen.

In the present invention, handheld data accuracy is critical for efficient sample collection procedures. Errors the present invention wishes to reduce and eliminate include for example, specimen container mislabeling or switching of labels, blood drawing into the wrong tube, incorrect collection order tube draw, wrong patient sample collection, or wrong time of draw.

The handheld may not have the updated information for providing patient care because the handheld data might have been altered and updated at a different handheld or desktop terminal since the handheld currently in use is accessed. If a user picks up a handheld and is not sure when the handheld was last updated, he or she will typically synchronize the handheld. Constant handheld synchronization is time consuming, interrupts the medical procedure flow, and is potentially exhaustive with regards to draining available network bandwidth.

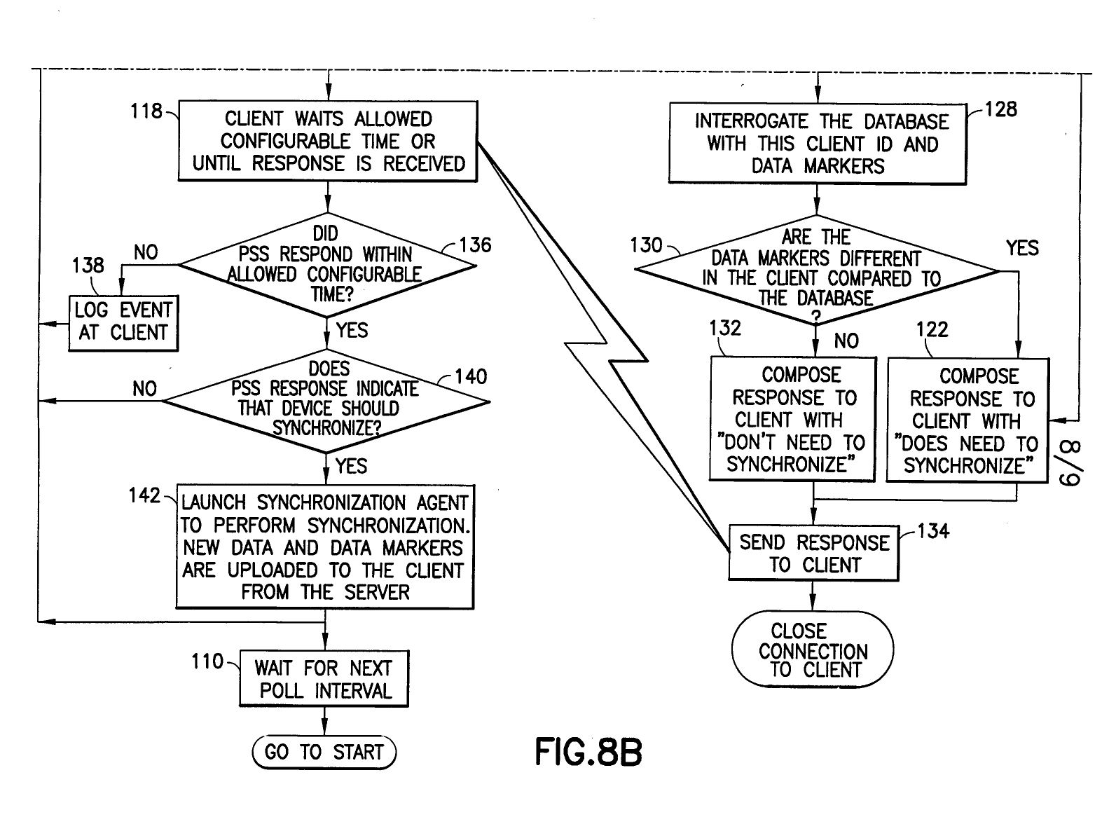

In one embodiment illustrated in FIG. 8, the synchronization process begins when the handheld client 22 is scheduled to poll the SMS 20 for new data, or when actuated by the user such as by introducing the handheld into the cradle (block 100). The handheld client 22 first initiates a query to determine if the network and SMS are available at a very minimum level (blocks 102, 104 and 106). For example, the handheld client 22 may have been disconnected from the server 20, or the server 20 is experiencing a high volume of traffic and is too busy to respond to the handheld 22 (i.e., no response is received within a predetermined time period), or the connection between the handheld 22 and the server 20 lacks sufficient bandwidth. The parameters such as the time period for response and the minimum bandwidth can be set for the handheld by a system administration. If the client is unable to connect to the SMS or establish an acceptable connection (e.g., with sufficient bandwidth and/or adequate server response time), the client logs (block 108) the attempt as a failure and waits for a poll interval or special event to try again (block 110). One example of such a query could be in the form of an ICMP echo request sent by the client (commonly referred to as a PING). If the server does not return an ICMP echo (PING) response to the handheld within a prescribed period of time, the connection is considered lost or interrupted.

If the connection attempt succeeds, the client builds (block 112) a structured data stream and sends it to the PSS 50. The PSS is capable of extracting the data sent from the client and determining if the client should synchronize. By way of an example, determining if synchronization is needed or not can involve a determination of which of the data at the client and the SMS is most current (e.g., modified or added most recently) and modifying the older data at one location with the corresponding and more current data at the other location. Further, the structured data stream can be, for example, a text stream comprising data fields indicating version number or handheld identifier, patient identifier, order, and container identifier, among other data fields, and state data such as respective time stamps or other data markers. The data markers can be bit counts that are incremented or decremented to show change relative to other data, or one or more bits representing a state of the data. In any case, the state data can indicate when the corresponding data was significantly changed or added, or merely indicate a change in the state of the corresponding data relative to similar data stored in another location. As the client sends the data to the PSS, it also starts a response timer (block 116) with resolution on the order of milliseconds. The client then waits for a response within its allowed wait time (block 118). The wait time is preferably configurable by a system vendor or system user (e.g., a client).

Meanwhile, once the PSS 50 receives data from the client (block 114), it continues receiving data until the entire structured data stream is received. The PSS first determines if the data stream from the client is structured in a format known to the server 20 (block 120). This initial check determines if the client and PSS share the same version and specific data structure (e.g., the PSS analyzes data from the data stream to locate a predetermined structured text stream containing one or more predetermined data fields such as handheld identifier and patient identifier, and state data indicating when the data in the data fields was significantly changed). If the PSS cannot understand the client's data stream, it immediately responds to the client with an order to synchronize without further processing (block 122). If the structured data stream is known to the PSS 50, it continues processing and extracts the device information (e.g., handheld identifier or user identifier) and data markers from the data stream for comparison to the SMS database 44 (block 124). The PSS 50 can immediately determine if the client made any modifications to the data or added new data by the sequence of data markers (block 126). In the case that modifications were made by the client, the PSS instructs to the client to begin the synchronization process without further processing (block 122). If there exists no evidence of modification by the client, the PSS 50 interrogates the SMS database 44 with the data markers provided by the client (block 128) to determine if the database has changed significantly enough for the client to require synchronization (block 130). The PSS responds to the client with the results of interrogation indicating whether or not the client needs to synchronize (blocks 132, 122 and 134).

The client continues processing until either a response is received from the PSS 50 or the response timer exceeds the allowed configurable time (block 136). If the response was not received within the allowed configurable time, the client logs (block 138) that the PSS 50 failed to respond and waits for the next poll interval or actuated event to try again. If the response occurs within the allowed configurable time, the client reads the response from the PSS 50 to determine if the client needs to synchronize with the server (block 140). If client reads a response from the PSS to synchronize, the client launches the synchronization agent 46 (block 142). Otherwise, if the response reads that synchronization is unnecessary at this time, the client notes in its settings that it is up to date at the current time, resets the Valid Data Timer, and continues normal operation.

The synchronization agent 46 connects to the server separately from the synchronization helper application 47 and performs the synchronization. During this synchronization, the data, data markers, and device information are uploaded from the SMS 20 so that the client 22 can communicate its new state to the PSS 50 at the onset of the next synchronization process. In an additional embodiment of the present invention, the PSS 50 interrogates the SMS database 44 with the data markers provided by the client 22 to determine if portions of the database relevant to information specific to physical locations assigned to the handheld have changed significantly enough for the client to require synchronization. Examples of physical locations are floors, wings, sections, or buildings of a hospital or equivalent medical facility. The PSS 50 responds to the client with the results of interrogation indicating whether or not the specific client needs to synchronize with the relevant data tables specific to the location. In this embodiment, the tables can be specific to specimen collection or medication administration information and therefore a subset of all of the patient information typically recorded in a HIS. Thus, the synchronization of the handheld is less time consuming when a selected portion of the data set stored therein is updated, as opposed to when synchronization causes the entire data set to be updated regardless of whether some of the data in the data set may have been current. In addition to being configured to only operate in a particular area (e.g., a selected floor, wing or ward in a healthcare setting), handhelds 22 can also be configured to collect only medical information from a particular group of patients, or only a particular type of medical information (e.g., blood sample collection) from a non-specified group of patients, based on the task assigned to a particular user of the handheld 22 or to the handheld itself. The SMS 20 can then use handheld or user identifier data provided in the request for synchronization sent from the client (i.e., handheld) 22 to determine if that particular subset of the data stored in the handheld 22 needs updating and therefore synchronization with the SMS. The SMS then preferably only needs to use the state data for that particular subset to determine if certain tables or portions of the data stored therein need to be synchronized with the handheld 22. In each of the above examples, it is to be understood that the handheld data may be more current than the corresponding data in the SMS, in which case the SMS updates this data during synchronization.

In a further embodiment of the present invention, which can operate in conjunction or independently of the aforementioned synchronization aspect described above, a valid data timer 54 (FIG. 5) can be employed to better ensure information on the handheld is substantially recent and up to date and therefore provides utility to the operator in understanding how well suited the data is for normal operator tasks such as processing and tracking patient specimen management order requests. A valid data timer element 54 communicates this information to the handheld user visually, mechanically, or audibly. This information can be presented in the form of indicating lapsed time since a last successful synchronization, indicating lapsed time since removing the handheld from a cradle or other connection to a server, indicating lapsed time since inserting the handheld into a cradle or other connection to a server, or optionally a countdown indicator indicating time until an expiration event occurs.

Usage of the valid data timer element 54 (FIG. 5) can prevent operators from executing operation orders with obsolete data. For example, once the valid data timer has expired or a predetermined amount of time has lapsed, the handheld can deactivate temporarily. The term “deactivate” temporarily means that some other event must occur before the handheld is able to resume normal operating conditions.

In accordance with another example, the handheld 22 tracks the duration since its last successful synchronization with a database, whereby upon exceeding a predetermined duration of time since synchronization with an external database through or on a server, an indicator is activated.

In a further embodiment of the present invention, the valid data timer element 54 communicates to the user when the handheld 22 was last synchronized with a database through a wireless network. This can take the form of a time display on the handheld screen displaying when the last synchronization to the wireless network was made or when the last time the handheld was capable of wireless network communication with a server.

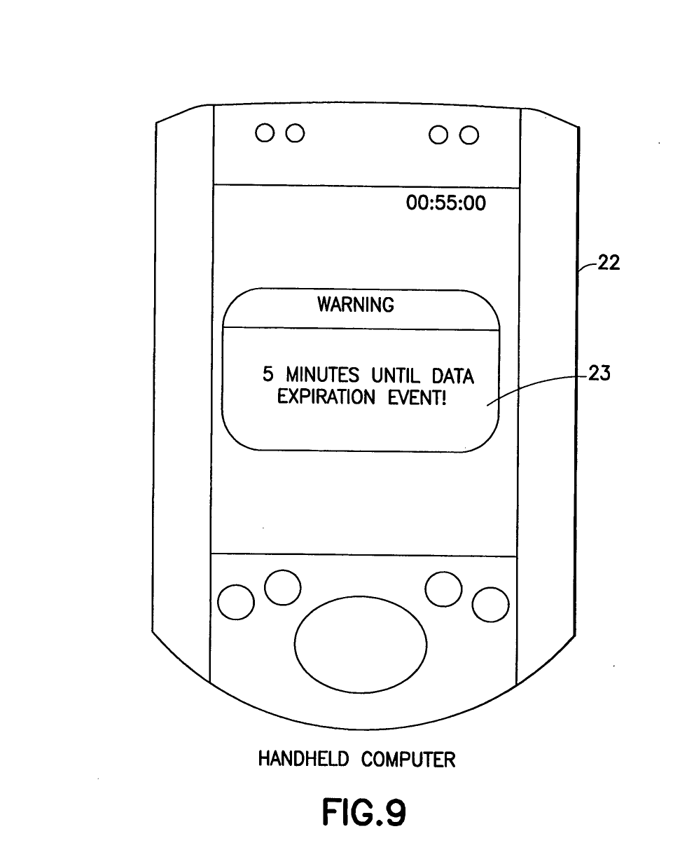

The valid data timer element 54 includes a function for indicating time with respect to lapsed time since a positive synchronization has taken place or time remaining till an expiration event will occur. This function can take the form of visual, mechanical, or audible elements. Examples include, but are not limited to, sounds generated by an acoustical generator element such as audible beeps, chirps, rings, whistles and the like, visual message displays, text warnings, light flashes, changing color displays, and mechanical indicators such as handheld vibrations, movements, and combinations thereof. With reference to FIG. 9, visual and message indicators can be displayed on the GUI such as the handheld screen 23 or possibly through a light emitting element such as an LED in communication with the handheld. Visual and message indicators can also include a timer display on the handheld screen indicating time in units of hours, minutes, or seconds, how much time has elapsed since synchronization, or countdown display indicating how much time is left prior to requiring synchronization.

Additionally, indicators can have multiple phases. For example, a dormant and active time period can exist, whereby after a certain amount of time has lapsed (expiration of the dormant phase and beginning of the active phase), the indicator will automatically display itself on the handheld screen. Other variations can include during a first phase there would be a displayable communication element indicating that the data is recent and fresh, wherein after the first phase expires and the new phase begins, an indicator will indicate to the user that the data isn't recent or fresh. The time periods set by the programmer will be able to communicate what time needs to lapse for the first stage to end and the new phase to begin.

With regard to resetting the valid data timer element, a user can be authorized, for example, with a password or system administrative code, so as to re-enable the handheld by, for example, hitting a reset button, wherein the reset button is on the handheld or cradle element and in two-way digital communication with the handheld. Other user intervention steps can involve the user synchronizing the handheld by introducing the handheld into a zone whereby the zone delimits radio frequency communication between the RF receiver integral with the handheld and a RF transceiver element within the zone.

User intervention can also be in the form of introducing the handheld itself into a cradle. One final example of user intervention might be activation of a software command executable on the handheld by activating an icon displayed on the handheld screen. This can be performing by an activation step such as contacting the touch type screen for data entry by pen (e.g. stylus) input operation.

Ideally, the valid data timer element can be programmed by one or more of the following entities including the handheld application programmer, the user, or a default setting programmed by the handheld or software supplier.

Although the above embodiments explore the scope of the present invention in the medical error management field, both the synchronization element and the valid data timer element can be applied to diverse environments requiring improvement in achieving efficient and reliable transmission of data between a server and portable computing device. Some possible uses of efficient synchronization and valid data timing outside the hospital setting include usage at curbside check-in at hotels and airports, table service at restaurants, school personnel record collection, and police ticketing. Other possible uses of efficient synchronization and valid data timing elements outside the hospital setting include inventory control in retail stores, warehouses, distribution centers, and manufacturing locations. The above uses can involve handhelds and servers managing products, containers, or widgets that comprise a barcode or RFID tags. Examples of products, containers, or widgets include but are not limited to boxes, crates, pallets, fifty-five gallon drums, canisters, mail, etc. An efficient method of synchronization of data is highly valuable to data acquisition and exportation. It is also important for portable computing device operators to understand the recentness of the data they are using to perform assigned duties.

As will be appreciated by one of skill in the art, the present invention may be embodied as methods, data processing systems, and/or computer program products. Accordingly, the present invention may take the form of an entirely hardware embodiment, an entirely software embodiment or an embodiment combining software and hardware aspects. By way of an example, the client 22 and the server 20 can comprise modules that are implemented in hardware, software or both. Furthermore, the present invention may take the form of a computer program product on a computer-usable storage medium having computer-usable program code embodied in the medium. Any suitable computer readable medium may be utilized including, but not limited to, hard disks, CD-ROMs, optical storage devices, and magnetic storage devices.

The present invention is described herein with reference to block diagrams and a flowchart illustration of methods, apparatus or systems, and computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagrams and/or flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks. I

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

As discussed herein, the client 22 is preferably a handheld. The client can be any computer product including circuitry capable of processing data. The computer may include, but is not limited to, general purpose computer systems (e.g., server, laptop, desktop, palmtop, personal electronic devices, etc.), personal computers (PCs), and the like. The handheld can be a personal digital assistant (PDA), but may include any portable computing device including, but not limited to a laptop, palmtop, cellular telephone, pager, watch or other wristband apparatus, internet appliance, or a application-specific portable electronic device. The client 22 can comprise modules that are implemented in hardware, software or both.

A communication link as described herein refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, and so on, and combinations thereof.

In accordance with the present invention, the patient information stored at the client 22, the server 20 (e.g., SMS), the LIS, among other locations, can be included in object-oriented and/or relational-type databases. The object-oriented databases are generally flexible in size and format, and do not have the rigid structure and space restrictions sometimes associated with table structure of the relational database, with its rows and columns, or records and fields. In a preferred embodiment, patient healthcare information is maintained in a relational database with defined tables of patient data with different fields (e.g., patient identifier, specimen container identifier, collection order number, and so on). Since healthcare relational databases are known, a description of the particulars of a healthcare database are omitted herein for conciseness.

If object-oriented databases are employed, however, and the field, record and update objects thereof do not actually exist in table form, an “embedded table” format can be used. For example, a collection of field objects can be depicted as a “table.” The column headings are field type, field length and field value. The rows identify a particular item of data. This “table” exists embedded within a record object. A collection of record objects can be depicted as another “table,” with the column headings of record type, unique record identifier and collection of field objects “table.” Each row is a single record object. This collection of records “table” can be embedded in the overall database “table.” A collection of update objects can be depicted as another “table,” with the column headings of: update length, unique patient identifier, unique update object identifier, a record object “table” containing its collection of field objects “table”, identification tags of intended destinations, update type identifiers, acknowledgment flags and audit fields. Each row is a single update object. This collection of updates “table” can be embedded in the overall database “table,” just the same as the collection of records “table.” The database “table” has column headings of unique patient identifier, collection of records “table” and collection of updates “table.” Each row contains a healthcare file of a particular patient.

Although the present invention has been described with reference to a preferred embodiment thereof, it will be understood that the invention is not limited to the details thereof. Various modifications and substitutions have been suggested in the foregoing description, and others will occur to those of ordinary skill in the art. All such substitutions are intended to be embraced within the scope of the invention as defined in the appended claims.

1. A method for efficiently updating in an asynchronous environment the data stored in portable computing devices with corresponding data stored in a database at a server or accessed via a server, the portable computing devices and database both being configured for use in a healthcare setting and comprising patient data, the method comprising the steps of:
establishing a connection between a portable computing device or PCD and the server;
sending a request for synchronization from the PCD to the server;
starting a response timer;
waiting for a response from the server within a selected wait time;
retransmitting the request for synchronization if a response was not received from the server within the selected wait time;
determining whether the PCD and server need synchronization, if the server successfully receives the request for synchronization, and generating a response for the PCD indicating either a need for synchronization or no need for synchronization; and
transmitting the response from the server to the PCD.

2. A method as claimed in claim 1, wherein the PCD is configured to store patient data in a PCD memory module, and the sending step for sending a request for synchronization comprises the step of generating and transmitting a data stream at the PCD that represents different types of the patient data that are stored in the PCD memory module and state data, the state data being configured to facilitate the determination at the server of whether at least a selected portion of the patient data stored in the PCD memory device is current relative to corresponding patient data stored in the database.

3. A method as claimed in claim 2, wherein the determining step comprises the steps of:
receiving the data stream at the server; and
using the state data in the data stream at the server to compare the different types of patient data in the data stream with corresponding patient data in the database to determine whether at least the different types of patient data in the PCD memory device is current relative to corresponding patient data stored in the database.

4. A method as claimed in claim 1, wherein the PCD is assigned for a specific use selected from the group consisting of use by a specific user, use in a selected physical location, and use for collection of a selected type of patient data, and the determining step comprises determining whether a subset of the patient data stored at the PCD requires synchronization, the subset of patient data corresponding to patient data collected for one of the specific uses.

5. A method as claimed in claim 4, wherein the PCD is configured to store patient data in a PCD memory module, and the sending step for sending a request for synchronization comprises the step of generating and transmitting a data stream at the PCD that represents different types of the patient data that is stored in the PCD memory module and state data, the state data being configured to facilitate the determination at the server of whether at least a selected portion of the patient data stored in the PCD memory device is current relative to corresponding patient data stored in the database, the data stream comprising at least one of a user identifier, a handheld identifier, and a location identifier to identify which selected portion of the patient data needs to be analyzed to determine whether if it requires synchronization with the database.

6. A method as claimed in claim 1, wherein the PCD operates a valid data timer, and further comprising the step of resetting the valid data timer after synchronization and when the response indicates a need for synchronization.

7. A method as claimed in claim 6, further comprising the step of the PCD changing its settings to indicate that the PCD is up to date at the current time.

8. A method as claimed in claim 1, wherein the PCD operates a valid data timer, and further comprising the step of resetting the valid data timer when the server determines that synchronization is not necessary.

9. A method as claimed in claim 8, further comprising the step of the PCD changing its settings to indicate that the PCD is up to date at the current time.

10. A method for efficiently updating in an asynchronous environment the data stored in portable computing devices with corresponding data stored in a database at a server or accessed via a server, the portable computing devices and database both being configured for use in a healthcare setting and comprising patient information, the method comprising the steps of:
establishing a connection between a portable computing device or PCD and the server for sending patient data thereto;
generating a structured data stream at the PCD comprising different types of patient data and corresponding state data that can be used to determine if the different types of the patient data were changed in a PCD memory device;
transmitting data comprising at least a portion of the patient data stored at the PCD and the structured data stream from the PCD to the server;
analyzing the data from the PCD received at the server for compatibility by determining if at least a portion of the structured data stream is recognized therein;
generating and transmitting from the server an order to the PCD to synchronize at least a portion of the patient data stored therein with corresponding patient data stored in the database if the server determines that the data is not in a compatible format; and
extracting state data from the data sent from the PCD to the server for comparison with corresponding data stored in a database at the server or accessed via the server and determining whether the PCD should synchronize with the database if the data is in a compatible format for the server.

11. A method as claimed in claim 10, wherein the state data comprises time stamps to indicate when the patient data was changed in a PCD memory device.

12. A method as claimed in claim 10, wherein the state data comprises data markers to indicate when the patient data was changed in a PCD memory device relative to corresponding patient data stored in another memory device.

13. A method for efficiently updating in an asynchronous environment the data stored in portable computing devices with corresponding data stored in a database at a server or accessed via a server, the method comprising the steps of:
establishing a connection between a portable computing device or PCD and the server for sending data thereto;
generating a structured data stream at the PCD comprising different data field types and state data that can be used to determine if the data for a corresponding data field type was changed in a PCD memory device;
transmitting data from the PCD to the server, the data comprising the structured data stream;
receiving the data from the PCD at the server;
analyzing at the server at least a portion of the state data received from the PCD to determine if the PCD changed the data, changes to the data comprising at least one of modifications to at least an existing selected portion of the data stored in the PCD and the addition of new data to the PCD;
sending an instruction from the server to the PCD to commence synchronization if the server determines that changes were made to the data stored in the PCD;
sending a response from the server to the PCD indicating that the PCD need not synchronize if the server determines that no changes were made to the data stored in the PCD and that the data stored in the PCT is current with respect to the corresponding data in the database or accessed via the server; and
sending an instruction from the server to the PCD to commence synchronization if the server determines that no changes were made to the data stored in the PCD but the data stored in the PCD is not current with respect to the corresponding data stored in the database or accessed via the server.

14. A method as claimed in claim 13, wherein the state data comprises data markers, and the analyzing step comprises the step of analyzing the sequence of the data markers to determine if the PCD made modifications to the data stored therein or added new data to the data stored therein.

15. A method as claimed in claim 13, further comprising the step of:
operating the server to interrogate the database associated therewith with the state data provided by the PCD to determine if the database has changed and requires synchronization.

16. A method as claimed in claim 15, further comprising the step of responding to the PCD with the results of interrogation indicating whether or not the PCD needs to synchronize.

17. A method as claimed in claim 13, wherein the transmitting step further comprises the steps of:
starting a response timer as the PCD sends the data to the server; and
waiting for a response from the server within a selected wait time.

18. A method as claimed in claim 17, wherein the response timer has a resolution on the order of milliseconds.

19. A method as claimed in claim 17, wherein the PCD waits for a subsequent poll interval or actuated event to retransmit the data if a response was not received from the server within the selected wait time.

20. A method as claimed in claim 19, wherein the PCD logs an event that the server failed to respond when a response is not received from the server within the selected wait time.

21. A method as claimed in claim 17, wherein if a response from the server occurs within the selected wait time, the method further comprises the steps of:
determining from the response transmitted from the server to the PCD whether the PCD needs to synchronize with the server; and
initiating synchronization if the response from the PSS instructs the PCD to synchronize.

22. A method as claimed in claim 13, wherein the PCD operates a valid data timer, and further comprising the step of resetting the valid data timer after synchronization and when the response indicates a need for synchronization.

23. A method as claimed in claim 22, further comprising the step of the PCD changing its settings to indicate that the PCD is up to date at the current time.

24. A method as claimed in claim 13, wherein the PCD operates a valid data timer, and further comprising the step of resetting the valid data timer after each synchronization when the server determines that synchronization is not necessary.

25. A method as claimed in claim 24, further comprising the step of the PCD changing its settings to indicate that the PCD is up to date at the current time.

26. A method as claimed in claim 13, wherein the state data comprises data markers, and the analyzing step comprises the step of analyzing the sequence of the data markers to determine if the PCD made modifications to the data stored therein or added new data to the data stored therein.

27. A method as claimed in claim 26, further comprising the step of uploading selected data and corresponding data markers from the database to the PCD during synchronization.

28. A method as claimed in claim 27, further comprising the step of the PCD communicating its new state to the server at the onset of the next synchronization process after uploading from database.

29. A method as claimed in claim 13, wherein the PCD is assigned to operate in a selected physical location and the data in the database comprises data specific to the selected physical location, and further comprising the step of the server interrogating the database with the data markers provided by the PCD to determine if portions of the database relevant to information specific to the selected physical location assigned to the PCD require synchronization.

30. A method as claimed in claim 29, wherein the physical locations are selected from the group consisting of a floor, a wing, a section of a building, or a building of a facility in which the PCD operates.

31. A method as claimed in claim 29, further comprising the step of transmitting from the server to the PCD interrogation results indicating whether or not the specific PCD needs to synchronize with relevant data tables specific to the selected physical location stored in the database.

32. A method as claimed in claim 31, wherein the data tables are specific to at least one of specimen collection and medication administration information to provide a subset of patient information recorded in a Hospital Information System or HIS.

33. A method as claimed in claim 13, wherein the server is a specimen management server and the data being synchronized between the portable computing device and at least one of the server and the database comprises at least one of specimen sample data, patient identifiers, specimen collection orders, cancellation order codes, and specimen collection container identifiers, user identifiers, PCD identifiers, and physical location identifiers.

34. A method as claimed in claim 13, wherein the server is connected to at least one of a patient database and a specimen order database, and the PCD and server are synchronized to allow tracking of collected specimens and matching to patient identification information stored in at least one of the patient database and specimen order database.

35. A method as claimed in claim 34, wherein said at least one of a patient database and a specimen order database is selected from the group consisting of a hospital information system or laboratory information system

36. A method for efficiently updating in an asynchronous environment the data stored in portable-computing systems with corresponding data stored in a database at a server or accessed via a server, the method comprising the steps of:
forwarding a query from a PCD to the server to determine if either the server or the network connecting the server to the PCD is unavailable;
when the PCD is unable to connect to the server, forwarding at least one other query from the PCD to the server after the occurrence of at least one of a predetermined interval of time and a predetermined event; and
when the PCD connects to the server, generating and sending a structured data stream to the server, the server being configured to extract data from the data stream sent from the PCD and determine if the PCD should synchronize with the server.

37. A method as claimed in claim 36, further comprising the step of logging a failed attempt event if the PCD is unable to connect to the SMS.

38. A method as claimed in claim 36, wherein the query is an ICMP echo request (PING).

39. A method as claimed in claim 38, wherein the server returns an ICMP echo (PING) response to the PCD within a prescribed period of time after the ICMP echo request (PING) if the connection is not terminated.

40. A method as claimed in claim 38, wherein the server returns an ICMP echo (PING) response to the PCD upon the occurrence of a predetermined event after the ICMP echo request (PING) if the connection is not terminated.

41. A method as claimed in claim 40, wherein the predetermined event is selected from the group consisting of a subsequent poll interval and a selected event.

42. A portable computing device or PCD for use in a healthcare setting comprising:
an input module for entering patient information;
a memory module for storing patient information;
a communication module for allowing the portable computing device to communicate with at least one of a server and a healthcare information database, the communication module comprising at least one of a wireless interface and a wireline interface for connecting to at least one other computing device or network of computing devices, the other computing device or network of computing devices comprising at least one of the server and the healthcare information database;
a cradle interface element for connecting the PCD to a cradle when placed therein, the cradle being configured for connection to at least the other computing device or network of computing devices;
a processing module connected to the memory, the input module, the cradle interface element and the communication module, and being programmable to automatically initiate synchronization of at least a portion of the patient information stored in the memory module with corresponding patient information stored in at least one of the server and the healthcare information database for updating, the synchronization being initiated when selected events occur, the selected events being selected from the group consisting of the placement of the portable computing device in the cradle and wireless communication with at least the other computing system to allow intermittent synchronization, the processing module being programmable to provide at least one of the server and the healthcare information database with state data corresponding to selected patient information in the memory module for the determination of whether the information in the memory module is in need of updating or not in need of updating.

43. A PCD as claimed in claim 42, wherein the input module comprises at least one of a keypad, a scanner, an imager, a radio frequency identification reader and an infrared identification reader.

44. A PCD as claimed in claim 42, further comprising an output module for selectively indicating the patient information to the user, the output module comprising at least one of a display, an audio output and a printer.

45. A PCD as claimed in claim 42, wherein the server is operable to send a response to the portable computing device indicating that synchronization is not necessary, the processing module being programmable to defer synchronization.

46. A PCD as claimed in claim 42, wherein the processing module is programmable to generate a structured data stream for transmission to at least one of the server and the healthcare information database, the structured data stream indicating the state data corresponding to a plurality of data types stored in the memory module and selected from the group consisting of patient identifiers, orders, specimen collection container identifiers, location identifiers, user identifiers, cancel order codes, and medication identifiers, the state data being configured to facilitate the determination by the server of whether or not at least a portion of the patient information in the memory module requires synchronization.

47. A PCD as claimed in claim 42, wherein the state data comprises at least one time stamp, and the processing module is programmable to receive and update only a portion of the patient information stored in the memory module from at least one of the server and the healthcare information database, the portion of the patient information corresponding to the patient information in the memory module that has changed in at least one of the server and the healthcare information database since the time stamp provided in the structured data stream.

48. A PCD as claimed in claim 42, wherein the memory module stores patient identifiers, and at least one of specimen collection orders, specimen collection container identifiers, and medication identifiers.

49. A PCD as claimed in claim 48, wherein the memory module further stores user identifiers and physical location identifiers where the portable computing device is assigned for use.

50. A PCD as claimed in claim 49, wherein the physical location identifiers correspond to healthcare locations selected from the group consisting of a ward, a section of a building, a floor, a section of a floor, and a building of a facility.

51. A PCD as claimed in claim 42, wherein the processing module operates a valid data timer element wherein to ensure information on the PCD is substantially recent and to communicate information to a user relating to the suitability of the data at the PCD for selected PCD operator tasks, the information being presented in a form selected from the group consisting of indicating lapsed time since a last successful synchronization, indicating lapsed time since removing the handheld from a cradle or other connection to the server, indicating lapsed time since inserting the handheld into a cradle or other connection to a server, and indicating time until an expiration event occurs when using a countdown module.

52. A portable communication device as claimed in claim 51, wherein the processing module is operable to control the PCD to deactivate temporarily once the valid data timer element has expired or a predetermined amount of time has lapsed.

53. A portable communication device as claimed in claim 51, wherein the processing module is programmable to control the PCD in tracking the duration of time since the last successful synchronization of the PCD with a database, and activating the data output module once a predetermined duration of time is exceeded since synchronization with an external database through or on a server.

54. A portable communication device as claimed in claim 51, wherein the processing module is programmable to control the data output module in accordance with dormant and active phases, the data output module being operated automatically after a certain amount of time has lapsed corresponding to the expiration of the dormant phase and the beginning of the active phase.

55. A portable communication device as claimed in claim 51, wherein the processing module is programmable to control the data output module in accordance with plural phases, the data output module indicating during a first phase that the data is recent, and indicating to the user that the data is not recent after the first phase expires and the a new phase begins.

56. A portable communication device as claimed in claim 55, wherein the processing module is programmable to operate with a time period set by the programmer for the selected amount of time that needs to lapse after the first stage before the new phase begins.

57. A portable communication device as claimed in claim 51, wherein the processing module is programmable to only allow resetting of said valid data timer element by a user with authorization via at least one of a password and system administrative code.

58. A portable communication device as claimed in claim 57, wherein an authorized user can re-enable the PCD by any one of a plurality of methods selected from the group consisting of hitting a reset button on the PCD or corresponding cradle element to commence two-way communication between the server and the PCD, synchronizing the PCD by introducing the PCD into a zone whereby the zone delimits radio frequency communication between an RF receiver integral with the PCD and a RF transceiver element within the zone, introducing the PCD into a cradle, activating a software command executable on the handheld by activating an icon displayed on the handheld screen.

59. A portable computing device (PCD) operating in a healthcare environment comprising:
a input module for receiving data relating to a patient;
a memory module for storing the data, the data comprising at least one physical location in which the PCD is assigned for use, patient identification data for at least the patients located at the physical location assigned to the PCD, and at least a subset of patient healthcare information comprising healthcare data for the patients located at the physical location assigned to the PCD, the healthcare data being selected from the group consisting of specimen sample data, patient identifiers, specimen collection orders, cancellation order codes, and specimen collection container identifiers, user identifiers, and physical location identifiers;
a processing module programmable, when PCD is placed in a cradle, to initiate synchronization with a server to update at least one of the patient identification data and the patient healthcare information stored in the memory module when the data therein is not current, and to defer synchronization to a subsequent time when the data therein is current.

60. A PCD as claimed in claim 59, further comprising an output module for selectively indicating the patient identification data and the patient healthcare information to the user, the output module comprising at least one of a display, an audio output and a printer.
